(19) United States
(12) Patent Application Publication
(10) Pub. No.: US 2002/0141929 A1
(43) Pub. Date: Oct. 3, 2002

(54) Synthesis of artificial human bone material

(76) Inventor: Chiranjeevirao Sonti, Newark (DE)

Correspondence Address: Charles E. Temko, Temko & Temko, 22 Marion Road, Westport, CT, 06880, US

(21) Appl. No.: 09/823,225

(22) Filed: Apr. 2, 2001

(51) Int. Cl. C01B 25/32

(52) U.S. Cl. 423/308

(57) ABSTRACT

A method of synthesizing artificial human bone material for use in orthopedic surgery using the chemical reaction of calcium nitrate, ammonium dihydrogen phosphate and ammonium hydroxide to obtain calcium hydroxy apatite.

### BACKGROUND OF THE INVENTION

This invention relates generally to the field of chemical synthetic products, and more particularly to the preparation of artificial human bone material chemically referred to as calcium hydroxy apatite with chemical formula of Ca10(PO₄)₆(OH)₂.

It is known in the art to synthesize this material over the past several decades using a variety of feed stocks or starting materials. Unfortunately, the resulting product has been calcium deficient, so that a true replica of human bone material has not been obtained. The processes employed have often required high temperatures, high pressures, or both, resulting in a calcium deficient apatite.

Normally, in conventional orthopedic surgery, the broken bones will be fixed using special metallic nails, the injury being subsequently enclosed in a plaster of paris cast. After three or four weeks time, the cast is removed, and an X-ray study will show the fracture to be healed. However, a superior result will be obtained using an implant with synthetically prepared artificial human bone material which will promote healing.

### SUMMARY OF THE INVENTION

Briefly stated, the invention contemplates a method of synthesizing artificial human bone material in powdered crystalline form which can be prepared as a flexible paste for use during a surgical procedure to form an implant in the area of the fracture or bone removal. The process may be performed at ambient temperatures and normal atmospheric pressure. The product, once produced, may be stored at room temperatures for an indefinite period, to be ready for use.

### DETAILED DESCRIPTION OF THE DISCLOSED EMBODIMENT

In the disclosed Example 1, approximately 100 grams of material is produced as a crystallin precipitated powder. Quantities stated are by metric weight and volume.

### EXAMPLE 1

To prepare 100 grams of artificial human bone material, the following solutions are prepared. Solutions 1 and 2 are stoichiometric quantities of very pure reactants, namely, calcium nitrate and ammonium dihydrogen phosphate to which is added a quantity of ammonium hydroxide to provide the following chemical reaction:

10Ca(NO3)₂+6(NH₄)H₂PO₄+14NH₄OH→Ca10(PO₄)₆(OH)₂ +2NH₄NO₃+12H₂O

The weighed chemicals are placed in separate one liter glass beakers and about 500 ml of deionized water are added following which the contents of the beakers are stirred until the chemical is completely dissolved. To the solutions 1 and 2, the ammonium hydroxide solution is carefully added to reach a Ph value of the resulting solution between 8-9.

Next, a three-necked glass vessel of two liter capacity is provided, and a glass thermometer is fixed within the center neck. The 500 ml of the prepared calcium nitrate solution is divided into two equal parts of 250 ml each, and one portion is poured into the three-necked vessel through one neck, using a funnel. The remaining 250 ml solution is diluted to 500 ml by adding 250 ml of deionized water. This diluted solution of calcium nitrate is placed into a 500 ml separating funnel, which in turn is fixed to one of the remaining necks of the three-necked glass vessel. 500 ml of ammonium dihydrogen phosphate solution is placed in another 500 ml separating funnel, and this funnel is fixed to the remaining neck of the three-necked vessel.

Next, the vessel is placed on a suitable heating plate which includes one component of a magnetic stirring means, wherein the contents of the vessel are heated to about 37 degrees C. (98.4 F.), following which the solutions from the separating funnels are added drop-wise to the three-necked vessel while the solution in the vessel is under constant stirring using a magnetically responsive pellet. Following the addition of the solutions from the separating funnels, the thermometer may be removed, to be replaced by a glass condenser cooled by circulating cold water which serves to condense vapors rising from the solution during heating and return the same to the solution. Heating is then continued for approximately one hour to improve the crystallin nature of the material obtained. It is to be noted that chemical reaction approximates 100 percent. Finally, the vessel is decanted to permit the prepared material to be vacuum filtered and separated from the liquid component. The resulting solid is preferably washed to completely remove any smell of ammonium hydroxide.

The obtained material is a replica of human bone material. This may be confirmed by chemical analysis, as well as sophisticated instrumental analysis such as SEM, TEM, IR, and electron diffraction to confirm that the prepared material has the chemical formula Ca10(PO₄)₆(OH)₂, and has unit cell volume of 0.99 A units.

I wish it to be understood that I do not consider the invention to be limited to the precise details of the disclosed example, for obvious modifications will occur to those skilled in the art to which the invention pertains.

I claim:

1. A synthesized artificial human bone material consisting of the reaction product of calcium nitrate, ammonium dihydrogen phosphate, and ammonium hydroxide.

2. The reaction product set forth in claim 1, having the formula Ca10(PO₄)₆(OH)₂.

3. The method of making a synthetic artificial human bone material which comprises the steps of:
a) providing stoichiometric quantities of calcium nitrate and ammonium dihydrogen phosphate;
b) providing a corresponding quantity of reactable ammonium hydroxide;
c) reacting the quantities set forth in steps (a) and (b) in accordance with the following reaction: 10Ca(NO₃)₂+6(NH₄)H₂PO₄+14NH₄OH→Ca10(PO₄) ₆(OH)₂+2NH₄NO₃+12H₂O.

4. The method in accordance with claim 3, including the steps of:
d) separating placing the calcium nitrate and ammonium dihydroxy phosphate in water solutions;
e) adding the ammonium hydroxide solution to bring the Ph value of the solutions to between 8 nd 9;
f) mixing the solutions in a common vessel, and heating the same to about 37 degrees C. for about one hour to form a crystallin precipitate, and;
g) filtering said precipitate.
